(19) United States
(12) Patent Application Publication
(10) Pub. No.: US 2003/0209902 A1
(43) Pub. Date: Nov. 13, 2003

(54) Method and apparatus for increasing the sale and exchange of children's books

(76) Inventor: Stephen D. Deadwyler, Washington, DC (US)

Correspondence Address: Alfred F. Hoyte, Esq., Suite 700, 733 15th Street, N.W., Washington, DC, 20005, US

(21) Appl. No.: 10/141,912

(22) Filed: May 10, 2002

(51) Int. Cl. B42D 1/00

(52) U.S. Cl. 281/15.1

(57) ABSTRACT

A method of doing business where the reading and exchange of children's books is promoted. A series of children's books, each having unique front and back cover illustrations, are each contained within a book bag having side panel illustrations matching the front and back cover illustrations. The book and book bag are sold together, with at least one compartment within the book bag sized to receive and contain the book. Children are encouraged to read other books in the series upon viewing the cover art associated with the books, the cover art serving to provide a preview of the contents of the book.

### BACKGROUND OF THE INVENTION

1. Field of the Invention

The present invention concerns children's books. More particularly, the invention is directed to a book bag specifically designed to promote the sale and exchange of a series of children's books.

2. Description of the Prior Art

Series of books, often called readers, designed for children, and especially small children just learning to read, have been in print for many years. The books are often characterized by extensive use of colorful illustrations, accompanied by large type. A limited vocabulary allows young readers to focus on, and master, a few basic words. The illustrations are typically directed to a core group of proprietary characters engaged in various and sundry adventures. As there are many such series of books, the ability to distinguish one series of books from another becomes increasingly difficult, given the many very well known series of children's books such as Dr. Seuss.®, Babar® The Elephant, Peanuts®, and, more recently, the Harry Potter® series.

One method of promoting children's books is to merchandise, based on specific characters. Past promotional schemes, even those used to promote, e.g., science fiction movies like Star Wars®, are directed to specific characters, although they may associate the characters with a particular book or movie.

Specialty book bags for children and adults that are not part of a promotion or merchandising scheme are well known in the art also. U.S. Pat. No. 4,958,759 issued to Jarvis shows a combined book cover and carrier designed to accommodate books having varying dimensions. U.S. Pat. No. 3,575,226 issued to Chapman discloses a handbag having replaceable side panels to ensure a match between the handbag and the attire worn by the handbag carrier. U.S. Pat. No. 6,237,825 issued to Pencoske discloses a transparent bag having pockets for displaying advertising material or the like. Finally, U.S. Pat. No. 4,243,340 issued to MacGregor discloses a briefcase having exterior pockets with transparent outer panels for the display of awards.

The present invention is directed to a method of promoting the sale of, and encouraging the exchange and reading of books between, especially, small children just starting to read. The inventive method includes the steps of providing a book bag for children having exterior illustrations matching that of a book contained therein, and selling the book and the book bag together.

### SUMMARY OF THE INVENTION

A method of doing business that promotes the reading and exchange of children's books. A series of children's books, each having unique front and back cover illustrations, are each contained within a book bag having side panel illustrations matching the front and back cover illustrations. The book and book bag are sold together, with at least one compartment within the book bag sized to receive and contain the book. Children are encouraged to read other books in the series upon viewing the cover art associated with the books, the cover art serving to provide a preview of the contents of the book.

It is a major object of this invention to provide a method of promoting the sale of a series of children's books.

It is another object to provide a method of encouraging children to read all of the books in a series of children's readers by providing a readily accessible visual preview of the content of all of the children's readers.

It is another object to provide a child's book bag having external illustrations matching the illustrations on the cover of a book contained therein.

It is another object to provide a child's book bag having external illustrations matching the illustrations on the cover of a book contained therein, and selling the book and book bag together at a price less than the price of the items if sold separately.

Finally, it is a general goal of the invention to provide improved elements and arrangements thereof in an apparatus for the purposes described which is dependable and fully effective in accomplishing its intended purposes.

These and other objects of the present invention will become readily apparent upon further review of the following specification and drawings.

The present invention meets or exceeds all the above objects and goals. Upon further study of the specification and appended claims, further objects and advantages of this invention will become apparent to those skilled in the art.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a plan view of a book bag to be used with the method of the present invention.

FIG. 2 shows a perspective view of the book bag shown in FIG. 1.

FIG. 3 shows a side view, partly in section, illustrating the placement of the book with matching illustration in the book bag.

### DETAILED DESCRIPTION OF THE PREFERRED EMBODIMENTS

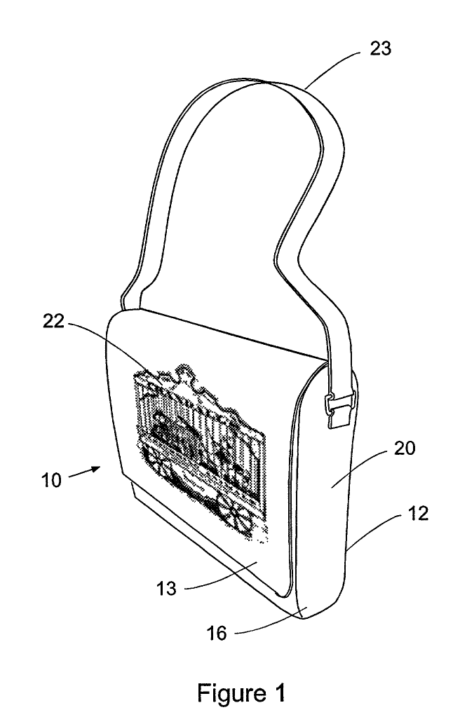

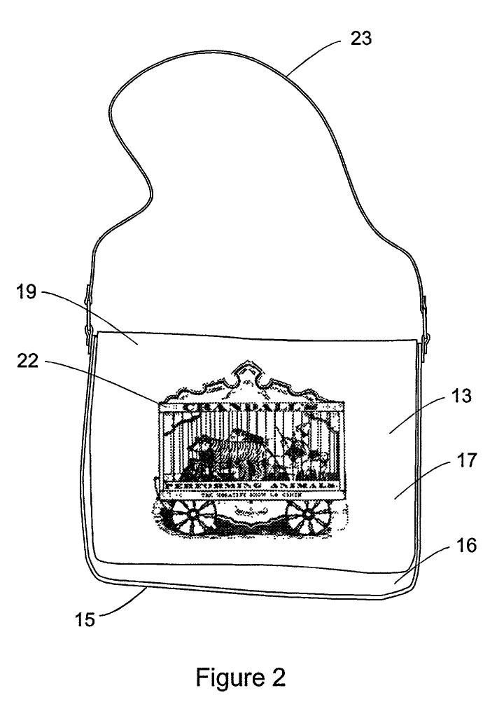

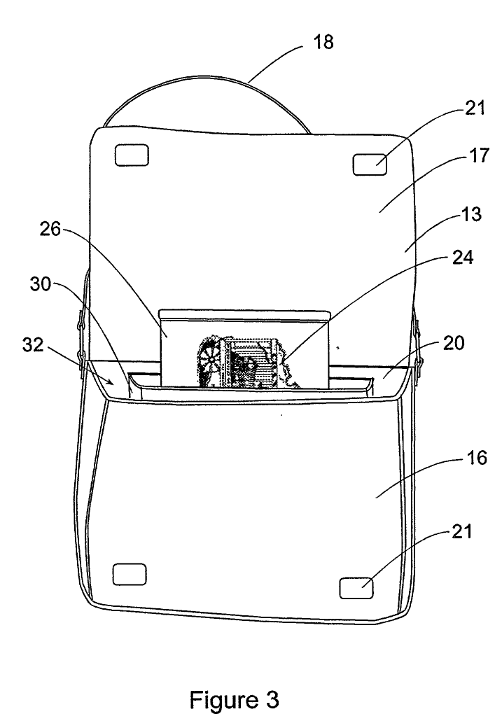

Referring now to FIGS. 1-3, the book bag to be used with the method of the present invention, generally indicated by the numeral 10, is shown. It can be seen that the book bag 10 is similar to conventional book bags for small children. Preferably, the book bag 10 is made from a heavy, waterproof, cloth material, having opposing, reinforced exterior side panels 12, 13. Side panels 12, 13 provide relatively large surfaces upon which illustrations may be rendered. Of course, the book bag 10 may have rigid sides and be configured like a briefcase, or have any other configuration provided it has a large enough interior space to contain books, and has large side panels to display illustrations as discussed above. It can be seen that side panels 12, 13 are formed from a continuous strip of material 19 extending from bottom edge 15 over and across the bag opening 20 and terminating in a closure portion 17. The closure portion 17 includes on an inner surface, one side of a hook and loop type fastener 21, allowing for fastening side panel 13 to interior side panel 16 with, e.g., Velcro® or other similar type of fastener. The book bag 10 includes shoulder straps 23 to allow a user to support the bag on his back. A handle (not shown) may optionally be positioned on the material 19 in an area above opening 20 when the side panel 13 is fastened.

By one aspect of the invention, the illustration 22 on the side panels 12, 13 is identical to the cover illustration 24 on one of a series of books, specifically children's books or readers. The illustration 22 may be rendered onto side panels using any well known image transfer technique. As is typical with children's readers, the book 26 details a simple adventure involving a minimum of characters, the illustration 22 serving to encapsulate the central theme of the story, by that serving as a preview to encourage young readers to read the story. Thus, each story is contained within a single book 10, the book having cover illustrations 24 corresponding to the particular story. Typically, book bags, lunch pails, and the like having illustrations, bear the illustrations for the sole purpose of marketing and merchandising. While the present invention is a part of an overall merchandising scheme, the illustration serves the primary purpose of encouraging the exchange, for reading, of all books in a series of children's readers among young readers. When a young child already familiar with the series of readers sees another child with a book bag 10 having different cover art from his or her book bag, he or she is immediately alerted to the fact that the other child may have a different book 26 in the series. If the child's curiosity is aroused, he or she may offer an exchange of books 26. It can be appreciated that this type of interchange between young students is beneficial from both an educational and social perspective. In accordance with another aspect of the invention, the book bag 10 may be sold without the book, the book bag 10 still having illustrated side panels 12, 13, with the illustration 22 matching the cover illustration 24 of a book in the series. It should also be noted that children's readers often have a different illustration on the front and back covers. If the book bag 10 is used as a backpack, it is preferable that the front cover be displayed when the book bag 10 is on the child's back. Thus the front cover would be rendered on side panel 13 if shoulder straps (not shown) were configured to allow for carrying the book bag 10 as a backpack, assuming that the closure portion 17 faces outward as is most often the case, with the back cover rendered on side panel 12. To ensure a sufficient diversity of stories, there should be at least 10 books with one or more stories contained therein, with each book having illustrations unique thereto. If the book 26 contains more than one story, each story would revolve around the central themes as depicted by illustrations 22, 24.

A pocket 30 is formed interiorly of side panel 13 and serves to contain the book 26. The pocket 30 preferably has a zippered opening or other closure means to prevent unintended removal of the book 26. Sufficient space is provided in the primary interior compartment 32 for other books, papers, pens, etc., the compartment 32 possibly including additional partitions, pockets, or segregated enclosures as is known in the art. Instead of an interior pocket immediately adjacent side panel 13, a zippered opening may be formed in side panel 12 to allow for removal of the book 26 from an exterior pocket without opening the bag 10. In either configuration, a transparent panel may be formed in side panel 12, 13 to allow for viewing of the front cover of the book 26, with the appropriate side panel 12, 13 displaying either a generic illustration germane to any book in the series, or the back cover of the book. It should be noted that to sustain an acceptable level of sales, the book bag 10 should be relatively inexpensive, the bag 10 perhaps priced at cost to encourage fans of the series to purchase more than one bag. Also, in accordance with another aspect of the invention, if the book bag 10 and the book 26 are purchased together, the price would be discounted over the price as sold separately.

In accordance with another aspect of the invention, a plurality of the bags 10 with corresponding book 26 contained therein, is offered for sale at the same time, so that fans of the readers are likely to encounter other fans having different books, resulting in an exchange of books as explained above. It can be appreciated that typically with readers, the books are released sequentially, and it may be a period of many months before there are a sufficient number of different books to implement the inventive method. A point of sale display (not shown) might include a complete list of all of the stories in the series, with a capsule summary of each story to allow parents to preview the contents of the story. The books 26 in the series might also be progressively more difficult, so that obtaining a bag 10 associated with the more difficult readers might be a source of pride and accomplishment for a young reader, in that his peers will presume he or she has advanced to a high level of reading competence.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. A method of preparing a series of children's books for sale and distribution, each book in the series having one or more unique stories printed and contained therein, the system comprising:
providing each of said books with unique cover illustrations;
providing a series of book bags corresponding to said series of children's books, each of said book bags in the series having external illustrations thereon corresponding to one of said unique cover illustrations associated with said books;
and enclosing an individual book of said series of books in each of said book bags, said individual book having a cover illustration identical to the external illustration of the book bag in which it is enclosed.

2. The method of claim 1 wherein said unique cover illustrations include both front and back cover illustrations, and including the step of rendering said external illustrations on said book bags on opposing side panels, with one of said side panels having the front cover illustration and the other of said side panels having the back cover illustrations.

3. The method of claim 1 wherein said book bags include an interior pocket, and further including the step of placing the book in said interior pocket.

4. The method of claim 3 wherein said book bag is sold with said book in said interior pocket.

5. A method for the sale and distribution of a series of children's books, each book in the series having one or more unique stories printed and contained therein, the method comprising:
providing each of said books with unique cover illustrations;
providing a series of book bags corresponding to said series of children's books, each of said book bags in the series having external illustrations thereon corresponding to one of said unique cover illustrations associated with said books,
whereby exchange of said book among readers of books in the series is encouraged upon mutual visual observation of said external illustrations on said book bags.

7. A series of book bags for sale with a corresponding series of children's readers, each book in said series of readers having a cover illustration unique thereto, each of said book bags comprising:
a generally rectangular main body having opposing sides with outwardly facing display surfaces having illustrations rendered thereon, said illustrations identical to one of said cover illustrations.

8. The series of book bags of claim 7 wherein each of said book bags has at least one interior pocket containing one of said books, the illustrations on said display surfaces identical to the cover illustration on said book.
